(19) United States
(12) Patent Application Publication
(10) Pub. No.: US 2025/0279433 A1
(43) Pub. Date: Sep. 4, 2025

(54) BINDER FOR DRY-COATED ELECTRODE

(71) Applicant: Arkema France, Colombes (FR)

(72) Inventors: Takehiro FUKUYAMA, Kyoto (JP); Laureline MARCHAL, Pierre-Benite Cedex (FR); Stephane BIZET, Serquigny (FR)

(21) Appl. No.: 18/858,765

(22) PCT Filed: Apr. 26, 2023
(86) PCT No.: PCT/EP2023/060948

§ 371 Date: Oct. 22, 2024

(30) Foreign Application Priority Data
Apr. 28, 2022 (FR) FR2204007

(51) Int. Cl. H01M 4/62; C08K 3/04; C09D 5/03; C09D 5/24; C09D 7/61; C09D 127/16; H01M 4/131; H01M 10/0525

(52) U.S. Cl. CPC H01M 4/623; C09D 5/031; C09D 5/24; C09D 7/61; C09D 127/16; H01M 4/131; H01M 10/0525; C08K 3/04; C08K 2201/001

(57) ABSTRACT

The present invention relates to a non-fibrillizable binder for a dry-coated electrode, said binder consisting of a fluoropolymer having a melting point between 145° C. and 200° C. measured according to ASTM D3418 and a melt viscosity below 50 kP measured at 230° C. and at a shear rate of 100 s-1 measured according to ASTM D3835. More specifically. the invention relates to a dry-coated electrode for Li-ion battery. The invention also concerns the lithium-ion batteries manufactured by incorporating said electrode.

### FIELD OF THE INVENTION

The present invention relates generally to the field of electrical energy storage in the lithium storage batteries of Li-ion type. More specifically, the invention relates to a non-fibrillizable binder for a dry-coated electrode for Li-ion battery. Another subject matter of the invention is a process for making an electrode using said binder. The invention also concerns the lithium-ion batteries manufactured by incorporating said electrode.

### BACKGROUND OF THE INVENTION

An elementary cell of a Li-ion storage battery or lithium battery comprises an anode (at discharge), and a cathode (likewise at discharge) generally made of a lithium insertion compound of metal oxide type, such as LiMn2O4, LiCoO2 or LiNiO2, between which is inserted an electrolyte which conducts lithium ions.

Rechargeable or secondary cells are more advantageous than primary (non-rechargeable) cells because the associated chemical reactions that take place at the positive and negative electrodes of the battery are reversible. The electrodes of secondary cells can be regenerated several times by applying an electrical charge. Many advanced electrode systems have been developed to store electrical charge. At the same time, much effort has been devoted to the development of electrolytes capable of improving the capabilities of electrochemical cells.

For their part, the electrodes generally comprise at least one current collector on which is deposited, in the form of a film, a composite material consisting of a so-called active material because it has an electrochemical activity with respect to lithium, a polymer which acts as a binder, plus one or more electronically conductive additives which are generally carbon black or acetylene black, and optionally a surfactant.

Binders are counted among the so-called inactive components because they do not directly contribute to the cell capacity. However, their key role in electrode processing and their considerable influence on the electrochemical performance of electrodes have been widely described. The main relevant physical and chemical properties of binders are the thermal stability, the chemical and electrochemical stability, tensile strength (strong adhesion and cohesion), and flexibility. The main objective of using a binder is to form stable networks of the solid components of the electrodes, i.e. the active materials and the conductive agents (cohesion). In addition, the binder must ensure close contact of the composite electrode to the current collector (adhesion).

Poly(vinylidene fluoride) (PVDF) is used binder in lithium-ion batteries because of its excellent electrochemical stability, good bonding capability and high adhesion to electrode materials and current collectors. PVDF can only be dissolved in certain organic solvents such as N-Methyl pyrrolidone (NMP), which is volatile, flammable, explosive, and highly toxic, leading to serious environment concern. Indeed, in the wet slurry process, active materials and binders are dispersed in a liquid solution. The liquid utilized are usually organic solvents or water. The dispersion is cast on a current collector then dried in a high temperature oven to produce an electrode. In this process, a high amount of energy is needed to dry out the liquid components of the slurry and organic solvents additionally produce harmful vapors which require special equipment to prevent free emission to the environment.

Compared to the conventional wet-suspension electrode manufacturing method, dry (solvent-free) manufacturing processes are simpler; these processes eliminate the emission of volatile organic compounds, and offer the possibility of manufacturing electrodes with higher thicknesses (>120 μm), with a higher energy density of the final energy storage device. The change in production technology will have little impact on the active material of the electrodes, however, the polymer additives responsible for the mechanical integrity of the electrodes must be adapted to the new manufacturing conditions.

US 2019/0305316 discloses dry process electrode films including a microparticulate non-fibrillizable binder having certain particle sizes and a method to obtain a film flexible enough to handle for a roll to roll process by using fibrillizable binders. However, the fibrillizable binders require either an extra shearing in addition to dispersing the components. This consumes high energy and destructive against the active materials. It is also known from US 2020/0313193 dry-process electrode films including an elastic polymer binder wherein the dry-electrode film is free standing and comprises at most an insubstantial amount of polytetrafluoroethylene. US 2020/0313193 mainly discloses polyethylene, as elastic polymer binder, which is not electrochemically stable enough for use in both cathode and anode of the lithium ion secondary batteries.

Therefore, there is still a need to develop new binders and electrode compositions for Li-ion batteries that are suitable for processing without the use of organic solvents.

### SUMMARY OF THE INVENTION

According to a first aspect, the present invention provides a non-fibrillizable binder for a dry-coated electrode, said binder consisting of a fluoropolymer having a melting point between 145° C. and 200° C. measured according to ASTM D3418 and a melt viscosity lower than 50 kP measured at 230° C. and at a shear rate of 100 s-1 measured according to ASTM D3835.

In particular, the melting point is defined as the temperature at the peak of melting endotherm measured according to ASTM D3418.

The present invention provides a binder with specific properties allowing the preparation of flexible free standing film. By using the fluoropolymer binder of the present invention, a ductile electrode film can be obtained through only one-step of mixing and dry process electrode application.

The present invention also provides binders free of fibrillizable materials to avoid additional shearing step. Therefore, the total energy consumption of the process is less compared to when fibrillizable binders are used.

Furthermore, the fluoropolymer binders according to the present invention are more electrochemically stable than polyethylene which allows higher capacity and cycle properties in the electrochemical cells using such electrodes.

According to a preferred embodiment, said fluoropolymer has a flexural modulus greater than 1000 MPa measured according to ASTM D790.

According to a preferred embodiment, said fluoropolymer comprises at least one fluoromonomer selected from the group consisting of vinylidene fluoride, trifluoroethylene, chlorotrifluoroethylene, hexafluoropropene, vinyl fluoride, hexafluoroisobutylene, perfluorobutylethylene, pentafluoropropene, 3,3,3-trifluoro-1-propene, 2,3,3,3-tetrafluoropropene, fluorinated vinyl ethers, fluorinated allyl ethers and fluorinated dioxoles.

According to a preferred embodiment, said fluoropolymer is selected from the group consisting of homopolymers and copolymers of vinylidene fluoride containing at least 50% by weight of vinylidene fluoride recurring units, the comonomer being selected from the group consisting of chlorotrifluoroethylene, hexafluoropropene and trifluoroethylene.

According to a preferred embodiment, the fluoropolymer is polyvinylidene fluoride (PVDF) homopolymer or a copolymer of vinylidene fluoride with hexafluoropropene.

According to a preferred embodiment, said fluoropolymer is a polyvinylidene fluoride homopolymer having head-to-tail defects in the chain of vinylidene fluoride units, and the degree of head-to-tail defects does not exceed 10%.

According to a preferred embodiment, said fluoropolymer comprises functionalized monomers in an amount of from 0.01 to 15 weight percent based on total monomer, preferably, from 0.05 to 5 weight percent based on total monomer and even more preferably in an amount from 0.05 to 1.5 weight percent based on total monomer.

According to a preferred embodiment, said functionalized monomers with at least one functionality are chosen from: acrylic acid, methacrylic acid, vinyl sulfonic acid, vinyl phosphonic acid, itaconic acid, maleic acid, and salts of such compounds; allyl glycidyl ether, methallyl glycidyl ether, crotonic acid glycidyl ether, and acetic acid glycidyl ether; ethylene carbonate; hydroxyl ethyl acrylate and hydroxyl propyl acrylate.

According to a preferred embodiment, said fluoropolymer is produced by either emulsion polymerization or suspension polymerization, preferably emulsion polymerization.

According to a preferred embodiment, said fluoropolymer is a powder having a particle size distribution with a Dv50 less than 20 μm, preferably less than 15 μm, in particular less than 10 μm.

The Dv50 is the particle size at the 50th percentile (in volume) of the cumulative size distribution of particles. This parameter can be determined by laser granulometry. This applies to all Dv50 recited in the present description. A Malvern INSITEC System particle size analyzer is used and the measurement is carried out by the dry route by laser diffraction on the powder with a focal of 100 mm.

According to a second aspect, the present invention provides a dry-coated electrode comprising the non-fibrillizable binder of the present invention, a conductive agent and a dry active material.

According to a preferred embodiment, the dry-coated electrode of claim 8, having the following mass composition:
a. 50% to 99.9% active material, preferably 50% to 99%,
b. 25% to 0% conductive agent, preferably 25% to 0.5%,
c. 25% to 0.05% non-fibrillizable binder, preferably 25% to 0.5%,
d. 0% to 5% of at least an additive selected from the group consisting of plasticizer, ionic liquid, dispersing agent for conductive additive, and flowing aid agent;
   the sum of all these percentages being 100%.

According to a preferred embodiment, said conductive agents comprise of one or more material from carbon blacks, such as acetylene black, Ketjen black; carbon fibers, such as carbon nanotube, carbon nanofiber, vapor growth carbon fiber; metal powders such as SUS powder, and aluminum powder.

According to a preferred embodiment, for a positive electrode said active material is selected from the group consisting of: LiCoO2, Li(Ni,Co,Al)O2, Li(1+x), NiaMnbCoc (x represents a real number of 0 or more, a=0.8, 0.6, 0.5, or ⅓, b=0.1, 0.2, 0.3, or ⅓, c=0.1, 0.2, or 1/3), LiNiO2, LiMn2O4, LiCoMnO4, Li3NiMn3O3, Li3Fe2(PO4)3, Li3V2(PO4)3, a different element-substituted Li Mn spinel having a composition represented by Li1+xMn2-x-yMyO4, wherein M represents at least one metal selected from Al, Mg, Co, Fe, Ni, and Zn, x and y independently representing a real number between 0 to 2, lithium titanate LixTiOy-x and y independently representing a real number between 0 to 2, and a lithium metal phosphate having a composition represented by LiMPO4, M representing Fe, Mn, Co, or Ni.

According to a preferred embodiment, for a negative electrode said active material is selected from the group consisting of: lithium alloy, a metal oxide, a carbon material such as graphite or hard carbon, silicon, a silicon alloy, and Li4TiO12.

According to a third aspect, the present invention provides a process for preparing the dry-coated electrode according to the present invention, said process comprising a thermo-mechanical treatment step carried out at a temperature ranging from 20° C. below the melting point of the non-fibrillizable binder up to 50° C. above the melting point of the non-fibrillizable binder.

According to a fourth aspect, the present invention provides a Li-ion battery comprising a positive electrode, a negative electrode and a separator, wherein at least one electrode is a dry-coated electrode according to the present invention.

The present invention allows to ensure the cohesion and mechanical integrity of the electrode, guaranteeing a good filmification or consolidation of the formulations that can be difficult to achieve for solventless processes; generate adhesion on the metal substrate; ensuring homogeneity of the electrode composition across the thickness and width of the electrode; ensure its homogeneity in the thickness and width of the electrode; reduce the overall binder content in the electrode, which in the case of known dry processes is still higher than in a standard slurry process. The advantage of this technology is to improve the following properties of the electrode: the homogeneity of the composition in the thickness, the cohesion, and the adhesion on the metallic substrate. It also allows the reduction of the binder rate required in the electrode, as well as the reduction of the temperature and duration of the heat treatment needed to improve the adhesion.

### DETAILED DESCRIPTION OF THE INVENTION

According to a first aspect of the present invention, a non-fibrillizable binder for a dry-coated electrode is provided.

The term “fluoropolymer” means a polymer formed by the polymerization of at least one fluoromonomer, and it is inclusive of homopolymers, copolymers, terpolymers and higher polymers which are thermoplastic. The fluoropolymer in certain embodiments of the invention contains at least 50 mole percent of one or more fluoromonomers, in polymerized form.

“Thermoplastic” is understood here to mean a non-elastomeric polymer. An elastomeric polymer is defined as being a polymer which can be drawn, at ambient temperature, to twice its initial length and which, after releasing the stresses, rapidly resumes its initial length, to within about 10%, as indicated by the ASTM in the Special Technical Publication, No. 184.

In a preferred embodiment, said binder consists of a fluoropolymer having a melting point between 145° C. and 200° C. measured according to ASTM D3418, preferably between 150° C. and 195° C., more preferably between 150° C. and 190° C., specifically between 150° C. and 185° C., more specifically between 150° C. and 180° C., in particular between 150° C. and 175° C., more in particular between 150° C. and 170° C., most in particular between 150° C. and 165° C., in a privileged manner between 150° C. and 160° C.

In a preferred embodiment, said binder consists of a fluoropolymer having a melt viscosity lower than 50 kP measured at 230° C. and at a shear rate of 100 s-1 measured according to ASTM D3835. Advantageously, said fluoropolymer has a melt viscosity lower than 48 kP, preferably lower than 46 kP, more preferably lower than 44 kP, specifically lower than 42 kP, more specifically lower than 40 kP measured at 230° C. and at a shear rate of 100 s-1 measured according to ASTM D3835. Preferably, said fluoropolymer has a melt viscosity greater than 1 kP, more preferably greater than 2 kP, in particular greater than 3 kP, specifically greater than 3.5 kP measured at 230° C. and at a shear rate of 100 s-1 measured according to ASTM D3835.

In a preferred embodiment, said binder consists of a fluoropolymer having a melting point between 145° C. and 200° C., preferably between 150° C. and 195° C., more preferably between 150° C. and 190° C., specifically between 150° C. and 185° C., more specifically between 150° C. and 180° C., in particular between 150° C. and 175° C., more in particular between 150° C. and 170° C., most in particular between 150° C. and 165° C., in a privileged manner between 150° C. and 160° C. measured according to ASTM D3418; and said fluoropolymer has a melt viscosity lower than 50 kP, advantageously lower than 48 kP, preferably lower than 46 kP, more preferably lower than 44 kP, specifically lower than 42 kP, more specifically lower than 40 kP measured at 230° C. and at a shear rate of 100 s-1 measured according to ASTM D3835.

Thus, said binder consists of a fluoropolymer having a melting point between 145° C. and 200° C., preferably between 150° C. and 195° C., more preferably between 150° C. and 190° C., specifically between 150° C. and 185° C., more specifically between 150° C. and 180° C., in particular between 150° C. and 175° C., more in particular between 150° C. and 170° C., most in particular between 150° C. and 165° C., in a privileged manner between 150° C. and 160° C. measured according to ASTM D3418; and said fluoropolymer has a melt viscosity lower than 50 kP, advantageously lower than 48 kP, preferably lower than 46 kP, more preferably lower than 44 kP, specifically lower than 42 kP, more specifically lower than 40 kP measured at 230° C. and at a shear rate of 100 s-1 measured according to ASTM D3835; and said fluoropolymer has a melt viscosity greater than 1 kP, preferably greater than 2 kP, more preferably greater than 3 kP, specifically greater than 3.5 kP measured at 230° C. and at a shear rate of 100 s-1 measured according to ASTM D3835.

In a preferred embodiment, said fluoropolymer has a flexural modulus greater than 1000 MPa measured according to ASTM D790. Advantageously, said fluoropolymer has a flexural modulus lower than 3000 MPa, preferably lower than 2900 MPa, more preferably lower than 2800 MPa, in particular lower than 2700 MPa, specifically lower than 2600 MPa, more specifically lower than 2500 MPa measured according to ASTM D790.

Thus, said binder consists of a fluoropolymer having a melting point between 145° C. and 200° C., preferably between 150° C. and 195° C., more preferably between 150° C. and 190° C., specifically between 150° C. and 185° C., more specifically between 150° C. and 180° C., in particular between 150° C. and 175° C., more in particular between 150° C. and 170° C., most in particular between 150° C. and 165° C., in a privileged manner between 150° C. and 160° C. measured according to ASTM D3418; and said fluoropolymer has a melt viscosity lower than 50 kP, advantageously lower than 48 kP, preferably lower than 46 kP, more preferably lower than 44 kP, specifically lower than 42 kP, more specifically lower than 40 kP measured at 230° C. and at a shear rate of 100 s-1 measured according to ASTM D3835; and said fluoropolymer has a flexural modulus greater than 1000 MPa measured according to ASTM D790.

Preferably, said binder consists of a fluoropolymer having a melting point between 145° C. and 200° C., preferably between 150° C. and 195° C., more preferably between 150° C. and 190° C., specifically between 150° C. and 185° C., more specifically between 150° C. and 180° C., in particular between 150° C. and 175° C., more in particular between 150° C. and 170° C., most in particular between 150° C. and 165° C., in a privileged manner between 150° C. and 160° C. measured according to ASTM D3418; and said fluoropolymer has a melt viscosity lower than 50 kP, advantageously lower than 48 kP, preferably lower than 46 kP, more preferably lower than 44 kP, specifically lower than 42 kP, more specifically lower than 40 kP measured at 230° C. and at a shear rate of 100 s-1 measured according to ASTM D3835; and said fluoropolymer has a flexural modulus greater than 1000 MPa measured according to ASTM D790 and lower than 3000 Mpa, preferably lower than 2900 MPa, more preferably lower than 2800 MPa, in particular lower than 2700 MPa, specifically lower than 2600 MPa, more specifically lower than 2500 MPa measured according to ASTM D790.

In a more preferred embodiment, said fluoropolymer has a melting point between 145° C. and 160° C., preferably between 150° C. and 160° C., measured according to ASTM D3418. Alternatively, said fluoropolymer has a melting point between 160° C. and 180° C. measured according to ASTM D3418.

In a more preferred embodiment, said fluoropolymer has a melt viscosity between 1 and 10 kP, preferably between 2 and 10 kP, more preferably between 3 and 9 kP measured at 230° C. and at a shear rate of 100 s-1 measured according to ASTM D3835. Alternatively, said fluoropolymer has a melt viscosity between 10 and 50 kP, preferably between 15 and 40 kP, more preferably between 20 and 40 kP measured at 230° C. and at a shear rate of 100 s-1 measured according to ASTM D3835.

In a more preferred embodiment, said fluoropolymer has a flexural modulus between 1000 Mpa and 1500 MPa, preferably between 1000 and 1400 MPa, more preferably between 1000 MPa and 1300 MPa measured according to ASTM D790. Alternatively, said fluoropolymer has a flexural modulus between 1300 and 3000 MPa, preferably between 1300 and 2750 MPa, more preferably between 1300 and 2500 MPa measured according to ASTM D790.

In a most preferred embodiment, said fluoropolymer has
a melting point between 145° C. and 160° C., preferably between 150° C. and 160° C., measured according to ASTM D3418,
a melt viscosity between 10 and 50 kP, preferably between 15 and 40 kP, more preferably between 20 and 40 kP measured at 230° C. and at a shear rate of 100 s-1 measured according to ASTM D3835.

In another most preferred embodiment, said fluoropolymer, preferably a polyvinylidene fluoride (PVDF) homopolymer, has
a melting point between 160° C. and 180° C. measured according to ASTM D3418,
a melt viscosity between 1 and 10 kP, preferably between 2 and 10 kP, more preferably between 3 and 9 kP measured at 230° C. and at a shear rate of 100 s-1 measured according to ASTM D3835.

In another most preferred embodiment, said fluoropolymer, preferably a polyvinylidene fluoride (PVDF) homopolymer, has
a melting point between 160° C. and 180° C. measured according to ASTM D3418,
a melt viscosity between 10 and 50 kP, preferably between 15 and 40 kP, more preferably between 20 and 40 kP measured at 230° C. and at a shear rate of 100 s-1 measured according to ASTM D3835.

In a particularly preferred embodiment, said fluoropolymer has
a melting point between 145° C. and 160° C., preferably between 150° C. and 160° C., measured according to ASTM D3418,
a melt viscosity between 10 and 50 kP, preferably between 15 and 40 kP, more preferably between 20 and 40 kP measured at 230° C. and at a shear rate of 100 s-1 measured according to ASTM D3835, and
a flexural modulus between 1000 Mpa and 1500 MPa, preferably between 1000 and 1400 MPa, more preferably between 1000 MPa and 1300 MPa measured according to ASTM D790.

In another particularly preferred embodiment, said fluoropolymer, preferably a polyvinylidene fluoride (PVDF) homopolymer, has
a melting point between 160° C. and 180° C. measured according to ASTM D3418,
a melt viscosity between 1 and 10 kP, preferably between 2 and 10 kP, more preferably between 3 and 9 kP measured at 230° C. and at a shear rate of 100 s-1 measured according to ASTM D3835, and
a flexural modulus between 1300 and 3000 MPa, preferably between 1300 and 2750 MPa, more preferably between 1300 and 2500 MPa, in particular between 1500 and 2500 MPa measured according to ASTM D790.

In another particularly preferred embodiment, said fluoropolymer, preferably a polyvinylidene fluoride (PVDF) homopolymer, has
a melting point between 160° C. and 180° C. measured according to ASTM D3418,
a melt viscosity between 10 and 50 kP, preferably between 15 and 40 kP, more preferably between 20 and 40 kP measured at 230° C. and at a shear rate of 100 s-1 measured according to ASTM D3835, and a flexural modulus between 1300 and 3000 MPa, preferably between 1300 and 2750 MPa, more preferably between 1300 and 2500 MPa, in particular between 1300 and 2000 MPa measured according to ASTM D790.

In a preferred embodiment, said fluoropolymer comprises at least one fluoromonomer selected from the group consisting of vinylidene fluoride, trifluoroethylene, chlorotrifluoroethylene, hexafluoropropene, vinyl fluoride, hexafluoroisobutylene, perfluorobutylethylene, pentafluoropropene, 3,3,3-trifluoro-1-propene, 2,3,3,3-tetrafluoropropene, fluorinated vinyl ethers, fluorinated allyl ethers and fluorinated dioxoles.

Preferably, said fluoropolymer comprises at least one fluoromonomer selected from the group consisting of vinylidene fluoride, trifluoroethylene, chlorotrifluoroethylene, hexafluoropropene and fluorinated vinyl ethers. In particular, said fluoropolymer comprises at least vinylidene fluoride recurring units.

In a particular embodiment, said fluoropolymer is selected from the group consisting of homopolymers and copolymers of vinylidene fluoride containing at least 50% by weight of vinylidene fluoride recurring units, the comonomer being selected from the group consisting of chlorotrifluoroethylene, hexafluoropropene and trifluoroethylene. Especially preferred copolymers are copolymers of vinylidene fluoride with hexafluoropropene, hexafluoropropene or chlorotrifluoroethylene, comprising from about 50 to about 99 weight percent vinylidene fluoride, more preferably from about 70 to about 99 weight percent vinylidene fluoride.

The term “PVDF” employed here comprises vinylidene fluoride (VDF) homopolymers or copolymers of VDF and of at least one other comonomer in which the vinylidene fluoride represents at least 50% by weight.

In a preferred embodiment, the fluoropolymer is polyvinylidene fluoride (PVDF) homopolymer or a copolymer of vinylidene fluoride with hexafluoropropene. Preferably, the fluoropolymer is polyvinylidene fluoride (PVDF) homopolymer or a copolymer of vinylidene fluoride with hexafluoropropene in which the level of HFP is less or equal to 50% by weight, advantageously less or equal to 40 wt. %, preferably less or equal to 30 wt. %, more preferably less or equal to 20 wt. %, in particular less than 10 wt. %, more in particular less than 8 wt. %. Thus, the copolymer of vinylidene fluoride with hexafluoropropene comprises vinylidene fluoride recurring units and hexafluoropropene recurring units.

Preferably, when said fluoropolymer is a copolymer of vinylidene fluoride with hexafluoropropene in which the level of HFP is less or equal to 50% by weight, advantageously less or equal to 40 wt. %, preferably less or equal to 30 wt. %, more preferably less or equal to 20 wt. %, in particular less than 10 wt. %; said fluoropolymer has:
a melting point between 145° C. and 160° C., preferably between 150° C. and 160° C., measured according to ASTM D3418,
a melt viscosity between 10 and 50 kP, preferably between 15 and 40 kP, more preferably between 20 and 40 kP measured at 230° C. and at a shear rate of 100 s-1 measured according to ASTM D3835.

More preferably, when said fluoropolymer is a copolymer of vinylidene fluoride with hexafluoropropene in which the level of HFP is less or equal to 50% by weight, advantageously less or equal to 40 wt. %, preferably less or equal to 30 wt. %, more preferably less or equal to 20 wt. %, in particular less than 10 wt. %; said fluoropolymer has
a melting point between 145° C. and 160° C., preferably between 150° C. and 160° C., measured according to ASTM D3418,
a melt viscosity between 10 and 50 kP, preferably between 15 and 40 kP, more preferably between 20 and 40 kP measured at 230° C. and at a shear rate of 100 s-1 measured according to ASTM D3835, and
a flexural modulus between 1000 Mpa and 1500 MPa, preferably between 1000 and 1400 MPa, more preferably between 1000 MPa and 1300 MPa measured according to ASTM D790.

In a particular embodiment, the fluoropolymer is polyvinylidene fluoride homopolymer or a copolymer of vinylidene fluoride with hexafluoropropene having head-to-tail defects in the chain of vinylidene fluoride units. The term “head-to-tail defects” refers to the inversion in the chain of vinylidene fluoride units. Preferably, the degree of head-to-tail defects does not exceed 10%. The degree of head-to-tail defects is measured by ¹⁹F-NMR. Advantageously, the degree of head-to-tail defects does not exceed 9%, preferably does not exceed 8%, more preferably does not exceed 7%, in particular does not exceed 6%, specifically does not exceed 5%, more specifically does not exceed 4%.

In another particular embodiment, the fluoropolymer is a copolymer of vinylidene fluoride with hexafluoropropene in which the level of HFP is less or equal to 15% by weight, advantageously less or equal to 14 wt. %, preferably less or equal to 13 wt. %, more preferably less or equal to 12 wt. %, in particular less than 11 wt. %, more in particular less than 10 wt %, most in particular less than 8 wt %; and wherein the hexafluoropropene recurring units are randomly distributed along the polyvinylidene fluoride backbone.

The fluoropolymer may further comprise monomers with at least one functionality chosen from carboxyl, epoxy, carbonyl or hydroxyl. Examples of monomers able to introduce carboxyl functionalities are unsaturated monobasic acid or unsaturated dibasic acid monomers in free acid, salt form, or anhydride form, selected from the group consisting of sulfonic acid groups, phosphonic acid groups and carboxylic acid groups and salts or anhydrides thereof. Such monomers are acrylic acid, methacrylic acid, vinyl sulfonic acid, vinyl phosphonic acid, itaconic acid, maleic acid, and salts of such compounds. Examples of monomers able to introduce epoxy functionalities are allyl glycidyl ether, methallyl glycidyl ether, crotonic acid glycidyl ether, and acetic acid glycidyl ether. Examples of monomers able to introduce carbonyl functionalities are ethylene carbonate. Examples of monomers able to introduce hydroxyl functionalities are hydroxyl ethyl acrylate and hydroxyl propyl acrylate.

The functionalized monomers may be used in an amount of from 0.01 to 15 weight percent based on total monomer. Preferably, they are used in an amount from 0.05 to 5 weight percent based on total monomer, and even more preferably in an amount from 0.05 to 1.5 weight percent based on total monomer.

The functionalized fluoropolymer is primarily produced via heterogeneous polymerization reactions, including suspension, emulsion and microemulsion systems. Generally, each of these reactions requires at least one acid-functionalized monomer or salt thereof, at least one fluoromonomer and a radical initiator in a suitable reaction medium. In addition, emulsion polymerizations of halogen-containing monomers generally require a surfactant capable of emulsifying both the reactants and the reaction products for the duration of the polymerization reaction.

According to one embodiment, the fluoropolymers used in the present invention are prepared by an emulsion polymerization process in the absence of a fluorinated surfactant.

In some variants, a process similar to that disclosed in document WO 2012/030784 may be used to prepare the functionalized fluoropolymers used in the present invention. The temperature used for polymerization may vary from 20 to 130° C. The pressure used for polymerization may vary from 280-20,000 kPa.

A pressurized polymerization reactor equipped with a stirrer and heat control means is charged with water, preferably deionized water, one or more functionalized monomers and at least one fluoromonomer. The mixture may optionally contain one or more of a surfactant, a buffering agent, an antifoulant or a chain-transfer agent for molecular weight regulation of the polymer product. Prior to introduction of the monomer or monomers, air is preferably removed from the reactor in order to obtain an oxygen-free environment for the polymerization reaction. The order in which the polymerization components are assembled may be varied, although it is generally preferred that at least a portion of the functionalized monomer is present in the aqueous reaction medium prior to the initiation of the polymerization of the fluoromonomer. An additional amount of functionalized monomer may be fed to the reactor during the reaction. In one embodiment, water, initiator, functionalized monomer and optionally surfactant, antifoulant, chain transfer agent and/or buffer are charged to the reactor, and the reactor heated to the desired reaction temperature. The fluoromonomer(s) is(are) then fed into the reactor, preferably at a rate which provides an essentially constant pressure. Alternatively the fluoromonomer, functionalized monomer and initiator can be fed to the reactor, along with one or more of the optional ingredients. The monomer feed is terminated when the desired weight of monomer has been fed to the reactor. Additional radical initiator is optionally added, and the reaction is allowed to react out for a suitable amount of time. The reactor pressure drops as the monomer within the reactor is consumed.

Upon completion of the polymerization reaction, the reactor is brought to ambient temperature and the residual unreacted monomer is vented to atmospheric pressure. The aqueous reaction medium containing the fluoropolymer is then recovered from the reactor as a latex. The latex consists of a stable mixture of the reaction components, i.e., water, surfactant, initiator (and/or decomposition products of the initiator) and functionalized fluoropolymer solids. The latex may contain from about 10 to about 50 weight percent polymer solids, preferably from 20 to 40% by weight. The polymer in the latex is in the form of small particles having a size range of from about 30 nm to about 800 nm.

Following polymerization, the fluoropolymer is agitated, thickened and dried.

The fluoropolymer thus obtained is treated to form a powder. The fluoropolymer powder may be obtained by various processes. The powder may be obtained directly by an emulsion or suspension synthesis process by drying by spray drying or by freeze drying. The powder may also be obtained by milling techniques, such as cryo-milling, where the fluoropolymer is brought to a temperature lower than room temperature, by means of liquid nitrogen as an example, prior to milling.

In a preferred embodiment, said fluoropolymer is a powder having a particle size distribution with a Dv50 less than 20 μm, preferably less than 15 μm, more preferably less than 10 μm. At the end of the powder manufacturing step, namely after the polymerization and the drying steps, the particle size can be adjusted and optimized by selection or screening methods and/or by milling in case of the Dv50 is above 10 μm. The particle size distribution mentioned herein is usually obtained when the fluoropolymer is prepared through an emulsion process.

In another preferred embodiment, said fluoropolymer is prepared through a suspension process.

In a second aspect of the present invention, a dry-coated electrode is provided. The dry-coated electrode comprises the non-fibrillizable binder according to the present invention, a conductive agent and a dry active material.

In a preferred embodiment, the dry-coated electrode has the following mass composition:
a. 50% to 99.9% active material, preferably 50% to 99%,
b. 25% to 0% conductive agent, preferably 25% to 0.5%,
c. 25% to 0.05% non-fibrillizable binder, preferably 25% to 0.5%,
d. 0% to 5% of at least an additive selected from the group consisting of plasticizer, ionic liquid, dispersing agent for conductive additive, and flowing aid agent;
   the sum of all these percentages being 100%.

The conductive agents in the dry-coated electrode comprise of one or more material that can improve conductivity. Some examples include carbon blacks such as acetylene black, Ketjen black; carbon fibers such as carbon nanotube, carbon nanofiber, vapor growth carbon fiber; metal powders such as SUS powder, and aluminum powder.

The active materials are materials that are capable of storing and releasing lithium ions.

In a preferred embodiment, said electrode is a negative electrode. In particular, for a negative electrode said active material is selected from the group consisting of lithium alloy, a metal oxide, a carbon material such as graphite or hard carbon, silicon, a silicon alloy, and Li4TiO12. The shape of the negative electrode active material is not particularly limited but is preferably particulate.

In another preferred embodiment, said electrode is a positive electrode. Preferably, for a positive electrode, said active material is selected from the group consisting of LiCoO2, Li(Ni,Co,Al)O2, Li(1+x), NiaMnbCoc (x represents a real number of 0 or more, a=0.8, 0.6, 0.5, or ⅓, b=0.1, 0.2, 0.3, or ⅓, c=0.1, 0.2, or ⅓), LiNiO2, LiMn2O4, LiCoMnO4, Li3NiMn3O3, Li3Fe2(PO4)3, Li3V2(PO4)3, a different element-substituted Li Mn spinel having a composition represented by Li1+xMn2-x-yMyO4, wherein M represents at least one metal selected from Al, Mg, Co, Fe, Ni, and Zn, x and y independently representing a real number between 0 to 2, lithium titanate LixTiOy-x and y independently representing a real number between 0 to 2, and a lithium metal phosphate having a composition represented by LiMPO4, M representing Fe, Mn, Co, or Ni.

In addition, the surface of each of the above-described materials may be coated. The coating material is not particularly limited as long as it has lithium ion conductivity and contains a material capable of being maintained in the form of a coating layer on the surface of the active material. Examples of the coating material include LiNbO3, Li4Ti5O12, and Li3PO4.

The shape of the positive electrode active material is not particularly limited but is preferably particulate.

The invention also relates to a process for preparing the dry-coated electrode, said process comprising a thermo-mechanical treatment step carried out at a temperature ranging from 20° C. below the melting point of the non-fibrillizable binder up to 50° C. above the melting point of the non-fibrillizable binder.

Said process for preparing the dry-coated electrode comprises the following steps:
mixing the active material, the non-fibrillizable binder of the present invention, and the conductive agent in powder form to prepare an electrode formulation;
depositing said electrode formulation on a substrate by a solventless process to obtain a Li-ion battery electrode, and
consolidation of said electrode by thermo-mechanical treatment carried out at a temperature ranging from 20° C. below the melting point of the non-fibrillizable binder up to 50° C. above the melting point of the non-fibrillizable binder.

The ingredients (said active material, said binder, said conductive agents and optionally the additive) are mixed in a powder form to prepare the electrode formulation.

Said process for preparing the dry-coated electrode comprises the following steps:
mixing the active material, the non-fibrillizable binder of the present invention in powder form as described above, and the conductive agent using a process that provides an electrode formulation applicable to a metal substrate by a “solventless” process;
depositing said electrode formulation on a substrate by a solventless process to obtain a Li-ion battery electrode, and
consolidation of said electrode by thermo-mechanical treatment carried out at a temperature ranging from 20° C. below the melting point of the non-fibrillizable binder up to 50° C. above the melting point of the non-fibrillizable binder.

A “solventless” process is one that does not require a residual solvent evaporation step after the deposition step.

A thermo-mechanical treatment refers to the application of a temperature from 20° C. below the melting temperature of the polymer up to 50° C. above the melting temperature of the polymer, with mechanical pressure. The pressure applied during the thermo-mechanical treatment is generally lower than 1 kN/mm, preferably lower than 0.75 kN/mm, more preferably lower than 0.5 kN/mm. Such thermo-mechanical treatment can be done by for example a calendaring machine with heatable rolls or a plate-plate press which can also be heated as well.

According to an embodiment, after the powder-mixing step, the electrode is manufactured by a solventless spraying process, by depositing the formulation on the metallic substrate, by a pneumatic spraying process, by electrostatic spraying, by dipping in a fluidized powder bed, by sprinkling, by electrostatic screen printing, by deposition with rotative brushes, by deposition with dosing rotative rolls, by calendering.

According to one embodiment, after the powder mixing step, the electrode is manufactured by a solvent-less process in two steps. A first step consists in manufacturing a free-standing film from the pre-mixed formulation with a thermo-mechanical process like extrusion, calendering or thermo-compression. In a second step, the free-standing film is laminated onto the metallic substrate by a process combining temperature and pressure like calendering or thermo-compression.

The mass ratio of conductive agents with respect to the active material is preferably from 0 to 10%, more preferably from 0 to 7%.

The mass ratio of binder with respect to the active material is preferably from 0.1 to 10%, more preferably from 0.5 to 7%.

According to an embodiment, the electrode components are all mixed at once according to conventional methods, leading to an electrode formulation.

In one embodiment, said electrode formulation is applied to a substrate by electrostatic screen printing. Some examples of substrate are current collectors such as metal foil and metal mesh, polymer films, or solid electrolyte layer of a solid-state battery.

The preferred thickness of an electrode is from 0.1 μm to 1000 μm, preferably from 0.1 μm to 300 μm.

In a third aspect of the present invention, a Li-ion battery is provided. Preferably, the Li-ion battery comprising a positive electrode, a negative electrode and a separator, wherein at least one electrode is a dry-coated electrode according to the present invention.

### EXAMPLES

The following examples illustrate the present invention without limiting it.

### Materials

PVDF 1: Homopolymer of vinylidene fluoride having a melting temperature of 165-172° C., a melt viscosity of 4-8 kP and a flexural modulus of 1655-2310 MPa.

PVDF 2: Homopolymer of vinylidene fluoride having head-to-tail defects (5.5% defects) and having a melting temperature of 161° C., a melt viscosity of 23.5-29.5 kP and a flexural modulus of 1380-1790 MPa.

PVDF 3: Copolymer of vinylidene fluoride and hexafluoropropylene (about 5% by weight of HFP) with acrylic acid moiety with a functionality of about 1% by weight characterized by a melting temperature of 151-157° C., a melt viscosity of 34-38 kP and a flexural modulus of 1030 MPa.

PVDF 4: Copolymer of vinylidene fluoride and hexafluoropropylene (about 5% by weight of HFP—randomly distributed) characterized by a melting temperature of 155-160° C., a melt viscosity of 23-27 kP and a flexural modulus of 1034-1241 MPa.

PVDF 5: Copolymer of vinylidene fluoride and hexafluoropropylene (about 12% by weight of HFP) characterized by a melting temperature of 140-143° C., a melt viscosity of 12-20 kP and a flexural modulus of 620-827 MPa.

PVDF 6: Copolymer of vinylidene fluoride and hexafluoropropylene (about 18% by weight of HFP) characterized by a melting temperature of 117-125° C., a melt viscosity of 5-16 kP and a flexural modulus of 192-276 MPa.

### Electrode Formulation

A negative electrode is prepared using each PVDF described above. 158-C (graphite, BTR) and binders were added to a 125 ml plastic bottle with lid. The ratio of 158-C and binder was 98.5/1.5 by weight. Zirconia beads were added to the container. The powder was mixed by ARE-310 (Thinky) at 2000 rpm for 30 sec. The mixed powder was sandwiched between two copper foils. The copper foil and powder were compressed in a roll press (SA-602, TESTER SANGYO CO., LTD.) at 160° C., 10 kN load, 0.5 m/min. speed. The prepared electrodes were bent into a U shape and considered OK if no cracks or breakage happens and considered as not OK (abbreviated “NOK”) if cracks or breakage were seen. Property of each binder tested and the results are shown in table 1.

TABLE 1

| Binder | Melting | Melt | | Flexural | | Bending |
|---|---|---|---|---|---|---|
| name | point | viscosity | | Modulus | | result |
| PVDF 1 | 168° C. | 6 | kP | 1982 | MPa | OK |
| PVDF 2 | 161° C. | 26.5 | kP | 1585 | MPa | OK |
| PVDF 3 | 154° C. | 36 | kP | 1030 | MPa | OK |
| PVDF 4 | 157° C. | 25 | kP | 1137 | MPa | OK |
| PVDF 5 | 142° C. | 16 | kP | 723 | MPa | NOK |
| PVDF 6 | 121° C. | 10 | kP | 234 | MPa | NOK |

Melting point measured according to ASTM D3418/Melt viscosity measured at 230° C. and at a shear rate of 100 s−1 according to ASTM D3835/Flexural Modulus measured according to ASTM D790

1. A non-fibrillizable binder for a dry-coated electrode, said binder consisting of a fluoropolymer having a melting point between 145° C. and 200° C. measured according to ASTM D3418 and a melt viscosity lower than 50 kP measured at 230° C. and at a shear rate of 100 s⁻¹ according to ASTM D3835.

2. The non-fibrillizable binder of claim 1, wherein said fluoropolymer has a Flexural Modulus greater than 1000 MPa measured according to ASTM D790.

3. The non-fibrillizable binder of claim 1, wherein said fluoropolymer comprises at least one fluoromonomer selected from the group consisting of vinylidene fluoride, trifluoroethylene, chlorotrifluoroethylene, hexafluoropropene, vinyl fluoride, hexafluoroisobutylene, perfluorobutylethylene, pentafluoropropene, 3,3,3-trifluoro-1-propene, 2,3,3,3-tetrafluoropropene, fluorinated vinyl ethers, fluorinated allyl ethers, and fluorinated dioxoles.

4. The non-fibrillizable binder of claim 1, wherein said fluoropolymer is selected from the group consisting of homopolymers and copolymers of vinylidene fluoride containing at least 50% by weight of vinylidene fluoride recurring units, the comonomer being selected from the group consisting of chlorotrifluoroethylene, hexafluoropropene and trifluoroethylene.

5. The non-fibrillizable binder of claim 1, wherein the fluoropolymer is polyvinylidene fluoride (PVDF) homopolymer or a copolymer of vinylidene fluoride with hexafluoropropene.

6. The non-fibrillizable binder of claim 1, wherein said fluoropolymer is a polyvinylidene fluoride homopolymer having head-to-tail defects in the chain of vinylidene fluoride units, and the degree of head-to-tail defects does not exceed 10%.

7. The non-fibrillizable binder of claim 1, wherein said fluoropolymer comprises functionalized monomers in an amount of from 0.01 to 15 weight percent based on total monomer.

8. The non-fibrillizable binder of claim 7, wherein said functionalized monomers are chosen from: acrylic acid, methacrylic acid, vinyl sulfonic acid, vinyl phosphonic acid, itaconic acid, maleic acid, and salts of such compounds; allyl glycidyl ether, methallyl glycidyl ether, crotonic acid glycidyl ether, and acetic acid glycidyl ether; ethylene carbonate; hydroxyl ethyl acrylate and hydroxyl propyl acrylate.

9. The non-fibrillizable binder of claim 1, wherein said fluoropolymer is produced by either emulsion polymerization or suspension polymerization.

10. The non-fibrillizable binder of claim 1, wherein said fluoropolymer is a powder having a particle size distribution with a Dv50 less than 20 μm.

11. Dry-coated electrode comprising the non-fibrillizable binder of claim 1, a dry active material and optionally a conductive agent.

12. The dry-coated electrode of claim 11, having the following mass composition:
a. 50% to 99.9% active material,
b. 25% to 0% conductive agent,
c. 25% to 0.05% of the non-fibrillizable binder,
d. 0% to 5% of at least an additive selected from the group consisting of plasticizer, ionic liquid, dispersing agent for conductive additive, and flowing aid agent;
the sum of all these percentages being 100%.

13. The dry-coated electrode of claim 11, wherein said conductive agents comprise of one or more materials selected from carbon blacks, carbon fibers; metal powders.

14. The dry-coated electrode of claim 11, wherein the dry-coated electrode is a positive electrode and said active material is selected from the group consisting of: LiCoO₂, Li(Ni,Co,Al)O₂, Li₍₁₊ₓ₎, NiₐMn_{b}Co_{c} (x represents a real number of 0 or more, a=0.8, 0.6, 0.5, or ⅓, b=0.1, 0.2, 0.3, or ⅓, c=0.1, 0.2, or ⅓), LiNiO₂, LiMn₂O₄, LiCoMnO₄, Li₃NiMn₃O₃, Li₃Fe₂(PO₄)₃, Li₃V₂(PO₄)₃, a different element-substituted Li Mn spinel having a composition represented by Li₁₊ₓMn_{2-x-y}M_{y}O₄, wherein M represents at least one metal selected from Al, Mg, Co, Fe, Ni, and Zn, x and y independently representing a real number between 0 to 2, lithium titanate LiₓTiO_{y}—x and y independently representing a real number between 0 to 2, and a lithium metal phosphate having a composition represented by LiMPO₄, M representing Fe, Mn, Co, or Ni.

15. The dry-coated electrode of claim 11 wherein the dry-coated electrode is a negative electrode and said active material is selected from the group consisting of: lithium alloy, a metal oxide, a carbon material hard carbon, silicon, a silicon alloy, and Li₄TiO₁₂.

16. A process for preparing the dry-coated electrode of claim 11, comprising a thermo-mechanical treatment step carried out at a temperature ranging from 20° C. below the melting point of the non-fibrillizable binder up to 50° C. above the melting point of the non-fibrillizable binder.

17. Li-ion battery comprising a positive electrode, a negative electrode and a separator, wherein at least one electrode is e the dry-coated electrode of claim 11.
